(19) United States
(12) Patent Application Publication
(10) Pub. No.: US 2021/0172038 A1
(43) Pub. Date: Jun. 10, 2021

(54) Process of Ceramic Proppant Production From Iron Ore and/or Sterile From Its Exploitation and/or Tailings From Its Beneficiation with Agglomeration of Fine and Ultrafine Particles - PCF

(71) Applicants: DJM EMPREENDIMENTOS MINERAIS E CONSULTORIA EM ENGENHARIA LTDA, Our Preto (BR); ACTT TECNOLOGIA E TREINAMENTOS AMFG LTDA, Our Preto (BR)

(72) Inventors: Jefferson Janurario Mendes, Ouro Preto (BR); Fernando Gabriel Da Silva Araujo, Ouro Preto (BR)

(21) Appl. No.: 16/705,582

(22) Filed: Dec. 6, 2019

(51) Int. Cl. C22B 1/16; C22B 1/24

(52) U.S. Cl. CPC C22B 1/16; C22B 1/2406

(57) ABSTRACT

The present patent document refers to the products and processes of Ceramic Proppant production from iron ore and/or sterile from its exploitation and/or tailings from its beneficiation, and/or fine and ultra-fine particles from other sources with similar properties, by agglomeration of these materials, and subsequent heat treatment, resulting from the combination of different technologies, previously used for other purposes, capable of obtaining a ceramic material, transforming the materials, including waste and sterile from other processes, into high value products, and reducing the impact of mining activity, with the best use of mineral resources.

In the future, this practice may allow for the reduction of waste and tailings disposal in new dams and piles, as well as the resumption of structures such as piles and old dams.

1. This invention patent, which concerns to the mining and metallurgical industry, relates to a process of Ceramic Proppant production from iron ore and/or sterile from its exploitation and/or tailings from its beneficiation by the agglomeration of these materials and subsequent heat treatment, resulting from the combination of distinct technologies previously used for other purposes, capable of obtaining a ceramic material, transforming raw materials and tailings into a product of high added value, and of course, to reduce the impact resulting from mining activity with the best use of mineral resources. This practice will reduce the disposal of tailings in new dams and the resumption of structures such as piles and old dams, helping to avoid damage to the environment.

2. For the contextualization of the proposed raw materials for the Ceramic Proppant described herein, it is essential to include, but not only, iron ore and/or sterile from its exploitation and/or tailings from its beneficiation, which typically contains as major phases, primarily, iron oxides, iron hydroxides, silica and clay minerals. Other raw materials of similar properties and origins, such as those from manganese exploitation, for example, can potentially be employed for the same purpose, and their uses are also encompassed by this patent.

3. A Proppant is a granular material used as supporting agents, when introduced into a fractured rock mixed with a liquid. This liquid is used in one of the oil well drilling techniques, which consists of opening fractures in the rock through a fluid at high pressure. Some of the requirements for such an application are suitable grain size and size distribution, with good sphericity, roundness and mechanical resistance.

4. The process of producing proppant from iron ore and/or sterile from its exploitation and/or tailings from its beneficiation, with fine and ultra-fine particles, consists in the wet mixing of particles, preferably in the fraction smaller than 0.148 mm, with predefined amounts of binder, basic and energetic oxides, all these optional, followed by agglomeration in pelletizer, which by the action of the surface tension of capillarity, promotes the formation of a good spherical agglomerate, which after placed on a specific heat treatment, has high mechanical resistance to handling.

5. The association of distinct technologies, previously used for other purposes, consists in the application of the present invention patent, in the use of:

Thickeners: Tanks or sedimentation equipment employed in a particular type of solid-liquid separation used to increase the concentration of solid pulp to values convenient for subsequent operations such as pumping and filtration. Filters: Equipment of the unitary filtration process, which consists of separating a solid phase from a liquid phase. Basically, an operation of separating solids present in a pulp, in which the liquid phase is compelled to pass through a porous medium, called filtering medium, while the solid phase, called filtration cake, forms a layer on the porous medium surface. Mixer and Intensive Mixer: Equipment for homogenizing the wet mix of raw materials with predefined amounts of binder, basic oxides and energy.

Roll or pelletizing disc: Equipment that revolves the mixture of raw materials for pellet formation (typically agglomerates of size from 6 mm to 20 mm in diameter) and mini-pellets (typically agglomerates of size less than 6 mm in diameter).

Heat treatment furnace: Equipment for the specific thermal processing of pellets and mini-pellets to obtain the Ceramic Proppant product with high mechanical resistance to handling.

Programmable Logic Controller (PLC): Device for controlling of all processing functions to increase quality and productivity with minimal operator supervision or intervention.

Ore Sorting Sieve: Equipment that aims to classify, according to size and final fit, in the particle size specification of the Ceramic Proppant.

6. The steps used to obtain the Ceramic Proppant (product) from the agglomeration and thermal processing of the iron ore and/or sterile from its exploitation and/or tailings from its beneficiation are as follows:

Step 1: Preparation of Raw Materials for Proppant Production.

The material goes through the processes of Thickening; Filtration; Homogenization; Additions (binder, flux) in appropriate proportions so that proppant pellets and mini-pellets acquire the physical and chemical characteristics specified for the process.

Step 2: Production of Raw Proppant Pellets and Mini-Pellets:

The mechanism of formation of raw proppant pellets and mini-pellets occurs from a phenomenon involving solid and liquid phases. The solid phases are typically the mixture of fines and ultrafines of iron ore and/or sterile from its exploitation and/or tailings from its beneficiation, additives and binders, and the liquid phase is typically water.

7. The physical process of agglomeration is due to the mechanical forces of compression and impact of the rolling of solid particles with water in the pelletizer (mixer, disc or roll), being influenced by the particle size distribution, the specific surface and the wettability of the particles, where the grains of the raw materials undergo successive bearings, whose rotational movement and proper inclination promote the agglomerate growth and later the formation of the proppant pellets and mini-pellets.

8. The quality of the raw proppant pellets and mini-pellets depends on the following variables: particle size distribution of the iron ore and/or sterile from its exploitation and/or tailings from its beneficiation and inputs; feed moisture; dosages of binders; rotation and inclination of the pelletizer; feed rate. These variables must ensure the proper residence time of the material within the pelletizer to produce granulometrically homogeneous and well finished pellets and mini-pellets. This means that good performance of the pelletizing process will result in good thermal processing performance.

Step 3: Thermal Processing of Proppant Pellets and Mini-Pellets.

9. During the thermal processing of the proppant pellets and mini-pellets a series of sequence reactions occur, governed by the physical and chemical parameters of the raw pellets and mini-pellets and the firing conditions. These reactions are responsible for the formation of a variety of compounds and phases, which together form the internal structure of the pellets and mini-pellets. These compounds and phases are responsible for the hardening and ultimate strength of pellets and mini-pellets. Each pellet and mini-pellet has typical quality associated with the type of ore, the additives and binders as well as the burning conditions used.

10. During the thermal processing of the proppant pellets and mini-pellets, the following stages occur:

Stage 1: Drying and Heating

Loss of adsorbed or capillary water and combined water occurs. In the drying process, while moisture is being eliminated, additive particles suspended in water and dissolved salts gradually increase their concentration until they begin to precipitate and solidify into small particles, combining with ore particles.

Stage 2: Pre-Burn

In the pre-burn phase, a series of reactions of fundamental importance to the quality of the pellets and mini-pellets occurs. This phase refers to a region of the furnace where the pellets and mini-pellets will be prepared for future reactions that will occur in the firing phase. The main typical reactions of this phase are:
Thermal decomposition of carbonates, hydroxides and clays/argil.
CaO reactions with other components.
   Thermal decomposition reactions of fluxing compounds.
   Thermal decomposition reactions of metal sulfides.
Transformation reactions of metal sulphides to sulphates.
Thermal decomposition reactions of kaolinite and bentonite clay minerals.

Stage 3: Burning

The construction of the internal phase structure of the pellets and mini-pellets occurs, concomitantly with the solid state sintering reaction, which will determine the structural density, pore structure and, as a consequence, the mechanical and permeability properties of the pellets and mini-pellets. After burning, the micro-pellets may show a variation in the composition of mineralogical phases depending on several factors, such as the chemical and mineralogical composition of the raw material and also the additives that were used.

11. In addition to these factors linked to the raw materials and inputs added to the pellets and mini-pellets, the mineralogical composition and quality of the micro-pellet also depend to a large extent on the burning conditions used, because each type of reaction and its products depend on the physicochemical conditions of the reaction medium, such as temperature, pressure and time spent in the firing phase.

Step 4: Obtaining the Ceramic Proppant (Product)

In this phase, the process of cooling the Ceramic Proppant obtained in the thermal processing occurs, and the classification according to quality, mechanical strength and particle size range, according to the product specifications.

12. For proper operation and efficiency, however, the process must be adjusted for each raw material to be treated and further adjustments are required below.
Dimensioning of production modules and equipment construction and operation parameters for different materials used as raw material.
Dimensioning of production modules aiming their viability with high efficiency and high production capacities and productivity, as it is fundamental in the mineral industry.
Possibility of including PLC with their respective adjustments.

13. This application introduces the possibility of additional steps of particle size suitability and size separation in the classification circuit. Such separation steps can be performed using any type of equipment, including sieves, rollers, mills, and can take place before entering the PCF process, at its output, or between units in series or in parallel with the process, taking its flows.

14. With this measure, the suitability and agglomeration of the fine and ultrafine particles of the iron ore and/or sterile from its exploitation and/or tailings from its beneficiation, using the PCF process, can be performed simultaneously on different equipment's, each of which acting to suit the specific granulometry size. This promotes a greater selectivity process, allowing a greater productivity and product quality.

15. With respect to prior existing processes, this application includes circuit optimization, suitable for the Ceramic Proppant production process, for different mineralogies, particle size range and type of material used PCF.

16. The production of Ceramic Proppants has the potential to add value to iron ore and/or sterile from its exploitation and/or tailings from its beneficiation, with special emphasis on the last two materials, as they are usually discarded, generating costs and environmental and safety impacts. Because of this, with the innovations described above, the following processes can be implemented:
Recuperation of tailings from sludge cyclones, tailings from mineral beneficiation and concentration;
Recuperation of the use of iron particles and iron oxides contained in materials resulting from steel processes, such as powders, sludge and slag;
Recuperation of considerable fraction of fine and ultrafine minerals by agglomeration process;
Reduction of waste resulting from mining activity, providing cleaner production, increasing the efficiency of the production process and yet without generating any strange residue to the region of exploitation, consisting of an environmentally sustainable or “green” technology.
Recuperation or utilization of any type of material or waste from iron mining.
Total recuperation of minerals and tailings of iron ore and fine and ultra fine particles.

17. The process has been developed and refined for various materials containing fine and ultrafine particles of iron ore and/or sterile from its exploitation and/or tailings from its beneficiation over 20 months, including application to sludge/tailings, flotation and magnetic separation, among others.

What is claimed is:

1. CERAMIC PROPPANT PRODUCED FROM IRON ORE AND/OR STERILE FROM ITS EXPLOITATION AND/OR TAILINGS FROM ITS BENEFICIATION, or similar materials, characterized by the production of ceramic pellets and mini-pellets, which have high mechanical resistance to handling and function as fracture support agents.

2. PROCESS OF PRODUCTION OF CERAMIC PROPPANT FROM IRON ORE AND/OR STERILE FROM ITS EXPLOITATION AND/OR TAILINGS FROM ITS BENEFICIATION, or similar materials, THROUGH AGGLOMERATION OF FINE AND ULTRA-FINE PARTICLES, TO FORM PELLETS AND MINI-PELLETS, characterized by wet mix of fine and ultrafine particles, with or without the addition of predefined amounts of binder, basic and energy oxides, followed by agglomeration process, for pellet and mini-pellet formation, which after undergoing a specific heat treatment have high mechanical resistance to handling.

3. PROCESS OF PRODUCTION OF CERAMIC PROPPANT BY THERMAL PROCESSING OF IRON ORE AND/OR STERILE FROM ITS EXPLOITATION AND/OR TAILINGS FROM ITS BENEFICIATION, or similar materials according to claim 1, characterized by the specific thermal processing step of iron ore and/or sterile from its exploitation and/or tailings from its beneficiation, with fine and ultra-fine particles to obtain the Ceramic Proppant product with high mechanical resistance to handling.

4. PROCESS OF PRODUCTION OF CERAMIC PROPPANT BY THERMAL PROCESSING OF IRON ORE AND/OR STERILE FROM ITS EXPLOITATION AND/OR TAILINGS FROM ITS BENEFICIATION, or similar materials according to claim 2, characterized by the specific thermal processing step of iron ore and/or sterile from its exploitation and/or tailings from its beneficiation, with fine and ultra-fine particles to obtain the Ceramic Proppant product with high mechanical resistance to handling.
